(19) United States
(12) Patent Application Publication
(10) Pub. No.: US 2005/0000323 A1
(43) Pub. Date: Jan. 6, 2005

(54) Winder for mechanical clocks

(76) Inventor: Charles Agnoff, Wilmington, NC (US)

Correspondence Address: WILLIAM J. MASON;MACCORD MASON PLLC, POST OFFICE BOX 1489, WRIGHTSVILLE BEACH, NC, 28480, US

(21) Appl. No.: 10/611,189

(22) Filed: Jul. 1, 2003

(51) Int. Cl. B25D 1/12

(52) U.S. Cl. 81/22; 81/54

(57) ABSTRACT

A winding device for use in winding pendulum or wind-up clocks includes an electrically powered rotary tool, such as an electric screwdriver, having a chuck, and at least one key having a distal end adapted for attachment to the clock spindle and a proximal end adapted for insertion into the chuck of the rotary tool. The tool or the key may include a torque limiter to prevent overwinding of the clock. The winding device may also include a key holder so that the tool can be used to wind a clock with its original key, the holder including a distal end for attachment to the original key, and a proximal end for insertion into the tool chuck. The key holder may also include a torque limiter.

### BACKGROUND OF THE INVENTION

(1) Field of the Invention

The present invention relates to keys for winding mechanical clocks with a powered rotary tool and to winding devices including such keys and a rotary tool.

(2) Description of the Prior Art

Mechanical clocks may be characterized as either mainspring wind-up clocks or pendulum clocks. In a wind-up clock, power is derived from a coiled metal strip having an inner end attached to an axle or spindle and an outer end fixedly attached to part of the clock mechanism, such as a housing around the spring. Rotation of the spindle in a clockwise manner compresses the spring, which exerts a rotative force on the spindle. An escapement comprised of an escapement wheel and anchor controls rotation of the spindle. The spindle also communicates with gears that are attached to the axles of the hour and minute hands of the clock. As the anchor “ticks” back and forth, the escapement wheel is allowed to turn one tooth at a time. As a result of the gearing from the spindle to the hand axles, the hands turn to show the proper time.

A pendulum clock operates in a similar manner, except that the rotational force is generated by a weight under the force of gravity. The weight is connected to the lower end of a cord or chain, which is attached at its upper end to a rotatable drum having an axle or spindle. Rotation of the spindle in a clockwise direction winds the cord around the drum, raising the weight. After winding, gravity urges the weight downwardly, in turn exerting a rotational force on the escapement and other clock gears. As in a wind-up clock, the anchor “ticks” back and forth, allowing the escapement wheel to rotate one tooth at a time. The anchor is connected to a pendulum, which controls the anchor's oscillation speed.

Mechanical clocks have provided effective timekeeping for many years, and remain popular even with the common availability of electrically powered clocks. This popularity is attributable, at least in part, to the appreciation of the beauty, efficiency and simplicity of clock mechanisms. However, winding of mechanical clocks, which is normally required at least weekly, can present a difficulty of aged or infirm individuals. In addition, the owner of several clocks, e.g., a collector of mechanical clocks, must spend considerable time in winding several clocks. Furthermore, there is a risk of winding the spring of a wind-up clock too tightly, damaging the clock or, in the case of light-weight clocks, causing the clock to tip over. The popularity and convenience of mechanical clocks would be further increased by addressing these needs.

### SUMMARY OF THE INVENTION

The present invention relates to a winding device for use in winding the drive mechanism of a mechanical clock that is useable by the elderly and infirm, that winds clocks quickly and that will not overwind the clock spring. The drive mechanism may be comprised of a mainspring having a spindle or a weight hanging from a cord extending around a drum having a spindle. In either drive mechanism, the winding device of the present invention is adapted to rotate the spindle, which may also be referred to as an axle, in a clockwise manner. Clockwise rotation of the spindle either increases the tension on the mainspring or raises the weight, depending on the drive mechanism.

The winding device is comprised of an electrically powered rotary tool having a chuck, and at least one key having a shank or shaft with a distal end adapted for attachment to a clock spindle and a proximal end adapted for insertion into the tool chuck. The rotary tool, which may be similar in some respects to an electric screwdriver, may be comprised of a handle having a knurled or resiliently covered outer surface to provide a firm grip, an electric motor, a switch, a battery in communication with the motor in circuit with the switch, a chuck, and a drive shaft connecting the motor to the chuck. Preferably, the battery is rechargeable and is housed within a recess in the handle. The rotary tool may have a back section and a front section, with the sections being joined by a hinge so that the rear section can be articulated relative to the front section, thereby creating a pistol grip. A torque limiter, which may be mechanical or electrical, e.g., a current sensor, may be positioned in communication with the drive shaft to prevent overwinding of the clock. Preferably, the tool drive mechanism, i.e., the motor and drive shaft, are irreversible. That is, unlike conventional electric screwdrivers and other power tools used to rotate a tool bit, current should only flow in one direction within the circuit so that the motor will only rotate the drive shaft in a clockwise direction.

The winding device may include one or more clockwinding keys, with each key being comprised of a shank having a proximal end adapted for insertion into the tool chuck and a distal end adapted for attachment to the clock spindle. The proximal end of the key may have a round cross-section, or a hexagonal or square cross-section to create a better grip when the chuck is tightened onto the proximal end of the key.

The clock spindle, whether of a spring or a drum, will be in the shape of a rod, normally having a hexagonal or square cross-section. If so, the distal end of the key will have a recess adapted to receive said spindle, with the recess having a cross-section substantially equal to the cross-section of the spindle. The key can also include a torque limiter between its proximal and distal ends, so that the distal end of the key will no longer turn when a predetermined resistance is detected, indicating that the clock is at its fully wound state.

If the device is comprised of a plurality of keys, the recesses may be of different sizes to accommodate different size spindles. The outer diameter of each key is also preferably kept to a minimum to permit insertion into the clock opening or aperture around the outer end of the spindle.

Instead of using a key having the above features, the user may desire to use the tool of the winding device with a regular clock winding key, that may have been originally provided with the clock. These original keys generally have a shank with a longitudinal axis, a proximal end having a gripping handle to be grasped within the user's fingers and a distal end adapted for attachment to the clock spindle. To enable use of the original key, the winding device may also include a key holder comprised of a shank having a longitudinal axis with a distal end adapted to releasibly grip the proximal end of the key, and a proximal end adapted for insertion into the chuck. The distal end may, for example, include a slot for receiving the gripping handle and a set screw extendable into the slot to releasibly secure the holder to the handle.

Alternatively, the distal end of the holder may include a spring-loaded clamp adapted to clamp onto the key's gripping handle. The key holder may further include a torque limiter between its first and second ends to prevent rotation of the key when a predetermined resistance is measured.

Some conventional clock winding keys also include a small key used to regulate the speed of the clock, as opposed to winding of the clock. This regulatory key may project rearwardly from the key handle. To permit positioning of the key holder onto the key handle, the key holder may include an axially aligned bore extending inwardly from the distal end of the key holder to receive the regulatory key.

### BRIEF DESCRIPTION OF THE DRAWINGS

FIG. 1 is a side view of a rotary tool with a key in the tool chuck.

FIG. 2 is a side view of one key embodiment.

FIG. 3 is an end view of the distal end of the key of FIG. 2.

FIG. 4 is a side view of another key embodiment.

FIG. 5 is an end view of the distal end of the key of FIG. 4.

FIG. 6 is a side view of another key embodiment including a torque limiter.

FIG. 7 is an end view of the distal end of the key of FIG. 6.

FIG. 8 is a side view of another key embodiment having a round shaft for insertion into the chuck of a rotary tool.

FIG. 9 is an end view of one end of the key of FIG. 8.

FIG. 10 is a side view of a conventional clock winding key.

FIG. 11 is an end view of the distal end of the key of FIG. 10.

FIG. 12 is a side view of an embodiment of a key adapter.

FIG. 13 is an edge view of the key adapter of FIG. 12.

FIG. 14 is a side view of an embodiment of a key adapter with a torque limiter.

FIG. 15 is an edge view of the key adapter of FIG. 14.

FIG. 16 is a side view of another embodiment of a key adapter.

FIG. 17 is an edge view of the key adapter of FIG. 16.

FIG. 18 is a side view of a conventional clock winding key including a regulatory key.

FIG. 19 is an end view of the proximal end of the key of FIG. 18.

FIG. 20 is an end view of the distal end of a key holder used to wind a key having the configuration of the key illustrated in FIGS. 18 and 19.

### DETAILED DESCRIPTION OF THE INVENTION

In the following description, terms such as horizontal, upright, vertical, above, below, beneath, and the like, are used solely for the purpose of clarity in illustrating the invention, and should not be taken as words of limitation. The drawings are for the purpose of illustrating the invention and are not intended to be to scale.

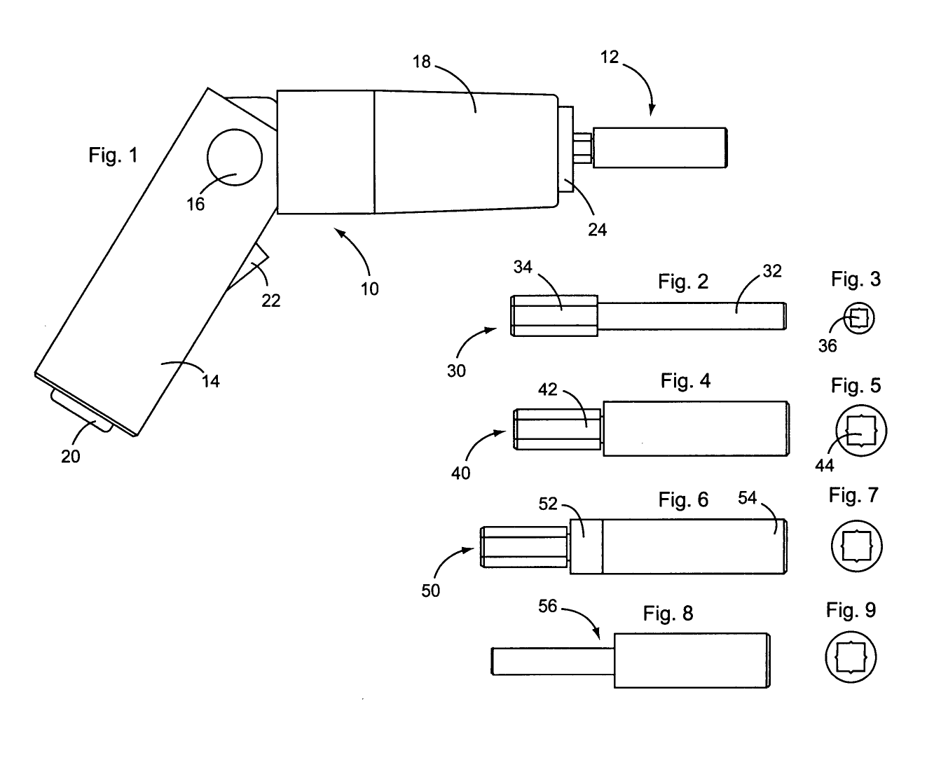

As best illustrated in FIGS. 1 and 2, the winding device is comprised of an electrically powered rotary tool, generally 10, and a key, generally 12. Tool 10 includes a handle 14 attached by hinge 16 to chuck 18. A rechargeable battery 20 is housed within handle 14 in a circuit with trigger 22 and an electric motor (not shown) adapted to rotate chuck 18. Preferably, the circuit is an irreversible circuit, permitting rotation of chuck 18 only in a clockwise direction, thereby preventing the user from accidentally attempting to unwind the spring or drum, potentially damaging the clock. Chuck 18 may also include a torque limiter 24.

FIGS. 2-7 illustrate keys that are useable with tool 10. FIGS. 2 and 3 illustrate a key, generally 30, that includes a shank or shaft 32 having a proximal end 34 with a hexagonal cross-section adapted to fit into chuck 18, and a distal end having a recess 36 adapted to receive the spindle of a clock (not shown). FIGS. 4 and 5 illustrate another key, generally 40, having a proximal end 42 with a hexagonal cross-section adapted to fit into chuck 18, and a distal end having a recess 44. Key 40 has the same diameter proximal end as key 30, but has a larger diameter recess and a larger diameter shaft. Generally, the shaft of a given key is only large enough to accommodate the desired recess, so that the shaft will be insertable into the opening or aperture around the clock spindle.

Key, generally 50, illustrated in FIGS. 6 and 7 has the same construction as key 40, except for the addition of torque limiter 52. With the addition of torque limiter 52, shaft 54 will cease to rotate when the resistance of the clock spindle reaches a predetermined fixed or adjustable value. FIGS. 8 and 9 illustrate a key, generally 56 with a recess at its distal end and a round shaft at its proximal end for insertion into the chuck of a rotary tool.

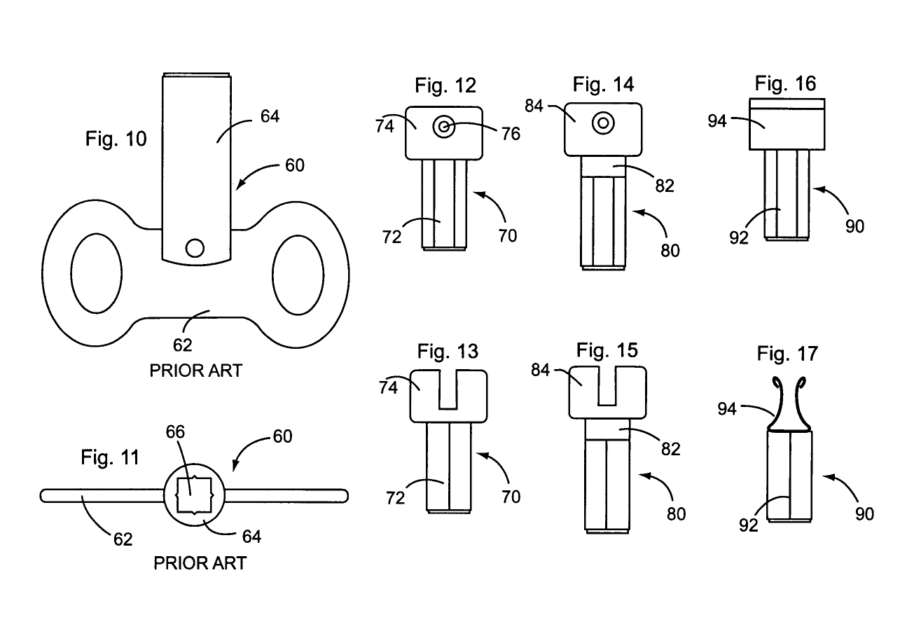

FIGS. 10 and 11 illustrate a conventional clock winding key, generally 60, of the type that is originally sold with a wind-up or pendulum clock. Key 60 includes a gripping handle 62 and a longitudinal shaft 64 that includes a clock spindle recess 66 in its distal end.

FIGS. 12 and 13 illustrate a key holder, generally 70, that can be used to rotate key 60 in chuck 18 of tool 10. Key holder 70 has a proximal end 72 with a hexagonal cross-section adapted for insertion into chuck 18 and a slotted distal end 74 for insertion onto gripping handle 62. In use, key holder 70 is inserted onto handle 62 and longitudinally aligned with shaft 64. Set screw 76 is then tightened to secure holder 70 onto key 60. Proximal end 72 is then inserted into chuck 18.

FIGS. 14 and 15 illustrate a key holder, generally 80, constructed similar to holder 70, except that holder 80 includes a torque limiter 82, which preforms a function similar to torque limiter 52. That is, distal end 84 will cease to rotate when the resistance of the clock spindle reaches a predetermined value. FIGS. 16 and 17 illustrate an alternative key holder, generally 90, having a proximal end 92 with a hexagonal cross-section for insertion into chuck 18 and a resilient clamp 94 at its distal end for insertion onto gripping handle 62.

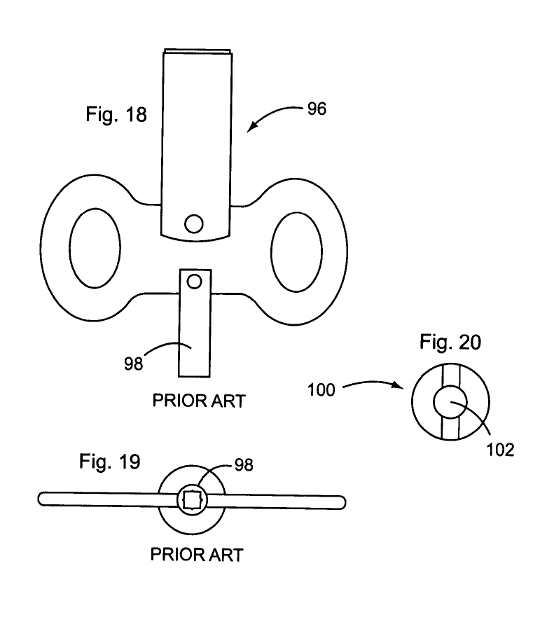

FIGS. 18 and 19 illustrate a conventional clock winding key, generally 96, similar to that shown in FIGS. 10 and 11. However, key 96 further includes a rearwardly extending regulatory key shaft 98. Key 96 can be turned with a key holder, generally 100, illustrated in FIG. 20, that is similar to key 70, but further includes an axial bore 102 for receiving shaft 98.

The winding device of the present invention may be sold in the form of a kit comprised of the rotary tool and a plurality of keys of different sizes for winding clocks with different size spindles. The kit may also include one or more key holders so that the user can also wind a clock with its original key.

Certain modifications and improvements will occur to those skilled in the art upon a reading of the foregoing description. It should be understood that all such modifications and improvements have been deleted herein for the sake of conciseness and readability but are properly within the scope of the following claims.

1. A key for use in winding a clock drive mechanism having a spindle with an electrically powered rotary tool having a chuck, said key having a distal end adapted for attachment to said spindle and a proximal end adapted for insertion into said chuck, said key further including a torque limiter between said proximal and distal ends.

2. The key of claim 1, wherein the proximal end of said key has a hexagonal cross-section.

3. The key of claim 1, wherein the distal end of said key has a recess adapted to receive said spindle, said recess having a cross-section substantially equal to the cross-section of said spindle.

4. The key of claim 3, wherein the said key recess has a square cross-section.

5. (canceled)

6. A winding device for use in winding a clock drive mechanism having a spindle comprised of:
a) an electrically powered rotary tool having a chuck and an irreversible drive rotatable only in a clockwise direction; and
b) at least one key having a distal end adapted for attachment to said spindle and a proximal end adapted for insertion into said chuck.

7. The winding device of claim 6, wherein the proximal end of said key has a hexagonal cross-section.

8. The winding device of claim 6, wherein the distal end of said key has a recess adapted to receive said spindle, said recess having a cross-section substantially equal to the cross-section of said spindle.

9. The key winding device of claim 8, wherein the said key recess has a square cross-section.

10. The winding device of claim 6, said key further includes a torque limiter between said proximal and distal ends.

11. The winding device of claim 6, wherein said rotary tool is battery powered.

12. (canceled)

13. The winding device of claim 6, wherein said rotary tool has a rear section and a back section, said sections being joined by a hinge.

14. The winding device of claim 6, wherein said device includes a plurality of keys adapted for attachment to spindles of different diameters.

15. The winding device of claim 6, wherein said rotary tool includes a torque limiter.

16. The winding device of claim 6, further including a key holder having a distal end adapted for releasibly holding a key and a proximal end adapted for insertion into said chuck.

17. A key holder for use in holding a clock winding key during winding of a clock drive mechanism having a spindle with an electrically powered rotary tool having a chuck; said clock winding key having a proximal end with a gripping handle, and a distal end adapted for attachment to said spindle; said key holder having a slotted distal end adapted for releasibly holding said key gripping handle and a proximal end adapted for insertion into said chuck.

18. (canceled)

19. The key holder of claim 17, further including a torque limiter between said key holder proximal and distal ends.

20. The key holder of claim 17, wherein said key holder proximal end has a hexagonal cross-section.

21. The key holder of claim 17, further including a gripping handle clamp.

22. The key holder of claim 17, further including a set screw extending into said slot to releasibly secure said holder to said key.
